(19) United States
(12) Patent Application Publication
(10) Pub. No.: US 2018/0121463 A1
(43) Pub. Date: May 3, 2018

(54) SYSTEM AND METHOD FOR ENRICHING A SEARCHABLE CONCEPT DATABASE

(71) Applicant: Cortica, Ltd., Tel Aviv (IL)

(72) Inventors: Adam HAREL, Tel Aviv (IL); Igal RAICHELGAUZ, Tel Aviv (IL); Karina ODINAEV, Tel Aviv (IL); Yehoshua Y ZEEVI, Haifa (IL)

(73) Assignee: Cortica, Ltd., TEL AVIV (IL)

(21) Appl. No.: 15/700,893

(22) Filed: Sep. 11, 2017

Related U.S. Application Data
(63) Continuation-in-part of application No. 15/296,551, filed on Oct. 18, 2016.
Application No. 15/296,551 is a continuation-in-part of application No. 14/643,694, filed on Mar. 10, 2015, now Pat. No. 9,672,217.
Application No. 14/643,694 is a continuation of application No. 13/766,463, filed on Feb. 13, 2013, now Pat. No. 9,031,999.
Application No. 13/766,463 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009, now Pat. No. 9,798,795.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009, now Pat. No. 9,798,795.
(60) Provisional application No. 62/393,024, filed on Sep. 11, 2016.
(60) Provisional application No. 62/310,742, filed on Mar. 20, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30156; G06F 17/30598; G06F 17/30023; Y10S 707/99948; G06F 17/30321; Y10S 707/99943; G06F 17/3002

(57) ABSTRACT

A system and method for enriching a concept database. The method includes determining, based on signatures of a first multimedia content element (MMCE) and signatures of a plurality of existing concepts in the concept database, at least one first concept; generating a reduced representation of the first MMCE by removing the at least one portion of the first MMCE matching the determined at least one first concept; comparing the reduced representation to signatures representing a plurality of second MMCEs to determine a plurality of matching second MMCEs for each portion of the reduced representation; determining metadata for each portion of the reduced representation; generating a second concept for each portion of the reduced representation, wherein each second concept includes a collection of signatures and the determined metadata for the respective portion; and adding the generated at least one second concept to the concept database.

### CROSS-REFERENCE TO RELATED APPLICATIONS

This application claims the benefit of U.S. Provisional Application No. 62/393,024 filed on Sep. 11, 2016. This application is also a continuation-in-part of U.S. patent application Ser. No. 15/296,551 filed on Oct. 18, 2016, now pending, which claims the benefit of U.S. Provisional Patent Application No. 62/310,742 filed on Mar. 20, 2016. The Ser. No. 15/296,551 application is also a continuation-in-part of U.S. patent application Ser. No. 14/643,694 filed on Mar. 10, 2015, now U.S. Pat. No. 9,672,217, which is a continuation of U.S. patent application Ser. No. 13/766,463 filed on Feb. 13, 2013, now U.S. Pat. No. 9,031,999. The Ser. No. 13/766,463 application is a continuation-in-part of U.S. patent application Ser. No. 13/602,858 filed on Sep. 4, 2012, now U.S. Pat. No. 8,868,619. The Ser. No. 13/602,858 application is a continuation of U.S. patent application Ser. No. 12/603,123 filed on Oct. 21, 2009, now U.S. Pat. No. 8,266,185. The Ser. No. 12/603,123 application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;

(3) U.S. patent application Ser. No. 12/348,888 filed on Jan. 5, 2009, now pending, which is a continuation-in-part of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a continuation-in-part of the above-referenced U.S. patent application Ser. Nos. 12/084,150; 12/195,863; and Ser. No. 12/348,888.

All of the applications referenced above are herein incorporated by reference.

### TECHNICAL FIELD

The present disclosure relates generally to content management, and more particularly to efficient organization and utilization of multimedia content.

### BACKGROUND

As content available over the Internet continues to exponentially grow in size and content, the task of finding relevant content has become increasingly cumbersome. Further such content may not always be sufficiently organized or identified, thereby resulting in missed content.

With the abundance of multimedia data made available through various means in general and the Internet and world-wide-web (WWW) in particular, there is a need for effective ways of searching for, and management of such multimedia data. Searching, organizing, and managing multimedia content generally and video data in particular may be challenging at best due to the difficulty of representing and comparing the information embedded in the video content, and due to the scale of information that needs to be checked.

Moreover, when it is necessary to find a content of video by means of textual query, prior art cases revert to various metadata solutions that textually describe the content of the multimedia data. However, such content may be abstract and complex by nature, and is not necessarily adequately defined by the existing metadata.

The rapid increase in multimedia databases, many accessible through the Internet, calls for the application of new methods of representation of information embedded in video content. Searching for multimedia content is challenging due to the huge amount of information that has to be priority indexed, classified and clustered. Moreover, existing solutions typically revert to model-based methods to define and describe multimedia content. However, by its very nature, the structure of such multimedia content may be too abstract and/or complex to be adequately represented by metadata.

A difficulty arises in cases where the target sought for multimedia content is not adequately defined in words that might be included in the metadata. For example, it may be desirable to locate a car of a particular model in a large database of video clips or segments. In some cases the model of the car would be part of the metadata but, in many cases it would not. Moreover, the car may be at angles different from the angles of a specific photograph of the car that is available as a search item. Similarly, if a piece of music, as in a sequence of notes, is to be found, it is not necessarily the case that the notes are known in their metadata form in all available content, or for that matter, the search pattern may just be a brief audio clip.

Searching multimedia content has been a challenge of past years and has therefore received considerable attention. Early systems would take a multimedia content element in the form of, for example, an image, compute various visual features from it, and then search one or more indexes to return images with similar features. In addition, values for these features and appropriate weights reflecting their relative importance could also be used. Searching and indexing techniques have improved over time to handle various types of multimedia inputs and handle them with ever increasing effectiveness. However, subsequent to the exponential growth of the use of the Internet and the multimedia data available there, these prior art systems have become less effective in handling the multimedia data, due to the vast amounts already existing, as well as the speed at which new ones are added.

Searching has therefore become a significant challenge, and even the addition of metadata to assist in the search has resulted in limited improvements. First, metadata may be inaccurate or not fully descriptive of the multimedia data, and second, not every piece of multimedia data can be accurately enough described by a sequence of textual metadata. A query model for a search engine has some advantages, such as comparison and ranking of images based on objective visual features, rather than on subjective image annotations. However, the query model has its drawbacks as well. Certainly when no metadata is available and only the multimedia data needs to be used, the process requires significant effort. Those skilled in the art will appreciate that there is no known intuitive way of describing multimedia data. Therefore, a large gap may be found between a user's perception or conceptual understanding of the multimedia data and the way it is actually stored and manipulated by a search engine.

The current generation of web applications has become more and more effective at aggregating massive amounts of data of different multimedia content, such as, pictures, videos, clips, paintings and mash-ups, and are capable of slicing and dicing it in different ways, as well as searching it and displaying it in an organized fashion, by using, for example, concept networks.

A concept may enable understanding of a multimedia data from its related content. However, current art is unable to add any real “intelligence” to the mix, i.e., no new knowledge is extracted from the multimedia data that are aggregated by such systems. Moreover, the systems tend to be non-scalable due to the vast amounts of data they have to handle. This, by definition, hinders the ability to provide high quality searching for multimedia content.

It would be therefore advantageous to provide a solution for the above-noted challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for enriching a searchable concept database. The method comprises: determining, based on signatures of a first multimedia content element (MMCE) and signatures of a plurality of existing concepts in the concept database, at least one first concept, wherein each first concept is one of the plurality of existing concepts matching a portion of the first MMCE; generating a reduced representation of the first MMCE, wherein the generation of the reduced representation includes removing the at least one portion of the first MMCE matching the determined at least one first concept; comparing the reduced representation to signatures representing a plurality of second MMCEs to determine a plurality of matching second MMCEs for each portion of the reduced representation; determining, based on the reduced representation and the signatures of the plurality of matching second MMCEs, metadata for each portion of the reduced representation; generating a second concept for each portion of the reduced representation, wherein each second concept includes a collection of signatures and the determined metadata for the respective portion; and adding the generated at least one second concept to the concept database.

Certain embodiments disclosed herein also include a non-transitory computer readable medium having stored thereon causing a processing circuitry to execute a process for enriching a searchable concept database, the process comprising: determining, based on signatures of a first multimedia content element (MMCE) and signatures of a plurality of existing concepts in the concept database, at least one first concept, wherein each first concept is one of the plurality of existing concepts matching a portion of the first MMCE; generating a reduced representation of the first MMCE, wherein the generation of the reduced representation includes removing the at least one portion of the first MMCE matching the determined at least one first concept; comparing the reduced representation to signatures representing a plurality of second MMCEs to determine a plurality of matching second MMCEs for each portion of the reduced representation; determining, based on the reduced representation and the signatures of the plurality of matching second MMCEs, metadata for each portion of the reduced representation; generating a second concept for each portion of the reduced representation, wherein each second concept includes a collection of signatures and the determined metadata for the respective portion; and adding the generated at least one second concept to the concept database.

Certain embodiments disclosed herein also include a system for enriching a searchable concept database. The system comprises: a processing circuitry; and a memory, the memory containing instructions that, when executed by the processing circuitry, configure the processing circuitry to: determine, based on signatures of a first multimedia content element (MMCE) and signatures of a plurality of existing concepts in the concept database, at least one first concept, wherein each first concept is one of the plurality of existing concepts matching a portion of the first MMCE; generate a reduced representation of the first MMCE, wherein the generation of the reduced representation includes removing the at least one portion of the first MMCE matching the determined at least one first concept; compare the reduced representation to signatures representing a plurality of second MMCEs to determine a plurality of matching second MMCEs for each portion of the reduced representation; determine, based on the reduced representation and the signatures of the plurality of matching second MMCEs, metadata for each portion of the reduced representation; generate a second concept for each portion of the reduced representation, wherein each second concept includes a collection of signatures and the determined metadata for the respective portion; and add the generated at least one second concept to the concept database.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a concept database enhancer according to an embodiment.

FIG. 2 is a flowchart illustrating a method for enriching a content database according to an embodiment.

FIG. 3 is a block diagram depicting the basic flow of information in the signature generator.

FIG. 4 is a diagram showing the flow of patches generation, response vector generation, and signature generation in a large-scale speech-to-text system.

FIG. 5 is a flow diagram illustrating concept database enrichment according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for enriching a concept database. Signatures are generated for an input multimedia content element. Based on the generated signatures, the multimedia content element is matched to one or more existing concepts stored in a concept database. Each concept is a collection of signatures and metadata describing the concept. A reduced representation of the input multimedia content element is generated. The reduced representation is a representation of portions of the multimedia content element excluding redundant portions such as MMCEs featuring concepts already existing in the concept database.

Based on the reduced representation of the input multimedia content element, matching reference multimedia content elements are searched for. The searching may include matching signatures of the reduced representation to signatures representing reference multimedia content elements in a database. Based on the reduced representation and the matching reference multimedia content elements, metadata to be added to a new concept is determined. Based on the determined metadata and the matched signatures, a new concept is generated. The new concept is added to the concept database, thereby enriching the knowledge of the concept database.

The concept database includes concepts which provide condensed representations of multimedia content. For example, various images and videos of cats may be represented by signatures generated for portions of multimedia content elements showing features of cats and metadata including the word “cats.” Thus, a concept database, as described herein, allows for reduced utilization of memory as compared to, for example, storing full representations of individual multimedia content elements.

The disclosed embodiments allow for enriching such a concept database. The enriched concept database provides representation of a larger number of concepts than an unenriched concept database, and provides for such enrichment more efficiently than manual enrichment (e.g., by manually selecting concepts to be added). Further, the enrichment provides for improved processing and memory utilization by excluding redundant concepts that are already present in the concept database from being used for enrichment.

The new concepts are self-tagged using metadata found based on the signatures to be included therein. Tagging based on the signatures further allows for more accurate identification of content represented by the concepts in the enriched database.

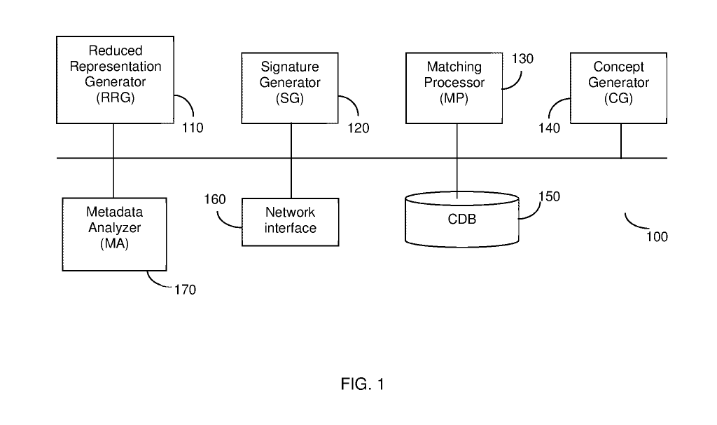

FIG. 1 shows an example schematic diagram of a concept database enhancer 100 for creating concept structures. The concept database enhancer 100 is configured to receive an input multimedia content element (MMCE, also referred to as a multimedia data element) from, for example, the Internet via a network interface 160. The MMCE may be, for example, stored in a database (not shown) or received from a user device (not shown).

MMCEs may be, but are not limited to, images, graphics, video streams, video clips, audio streams, audio clips, video frames, photographs, images of signals, combinations thereof, and portions thereof. The images of signals are images such as, but not limited to, medical signals, geophysical signals, subsonic signals, supersonic signals, electromagnetic signals, infrared signals, and combinations thereof.

The input MMCE is analyzed by a signature generator (SG) 120 to generate signatures thereto. The operation of the SG 120 is described in more detail herein below. Each signature represents a concept structure, and may be robust to noise and distortion. Each concept structure, hereinafter referred to as a concept structure, is a collection of signatures representing multimedia content elements and metadata describing the concept, and acts as an abstract description of the content to which the signature was generated. As a non-limiting example, a ‘Superman concept’ is a signature-reduced cluster of signatures representing elements (such as MMCEs) related to, e.g., a Superman cartoon: and a set of metadata including a textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

It should be noted that using signatures for generating reduced representations of content shown in MMCEs ensures more accurate identification of concepts featured therein than, for example, based on metadata alone. Specifically, the signatures, as described herein, allow for recognition and classification of multimedia content elements.

A matching processor (MP) 130 is configured to match the generated signatures to signatures existing in a concepts database (CDB) 150. To this end, the MP 130 may be configured to compare signatures and generate a matching score for each generated signature with respect to one or more of the existing concepts. The MP 130 may be further configured to determine each portion of the input MMCE matching an existing concept. The determination may include, for example, determining whether each portion of the input MMCE matches one or more existing concepts above a predetermined threshold. A portion of an MMCE may match an existing concept when, for example, signatures representing the portion match signatures representing or included in the existing concept above a predetermined threshold.

In some implementations, the MP 130 may be configured to perform a cleaning process based on the matching. The cleaning process may include removing signatures of portions that match existing concepts. The cleaning process may be performed recursively, for example, after each time a matching concept is found. The cleaning process allows for increased efficiency and reduced utilization of computing resources while searching for matching concepts. It should be noted that the cleaning process may limit the scope of potential matches and, therefore, is optional. Further, whether to perform the cleaning process may be determined based on the degree of matching, the matching concepts, or both.

Based on the matching, a reduced representation generator (RRG) 110 is configured to generate a reduced representation of the input MMCE. The reduced representation is a representation of portions of the input MMCE excluding any portions that match existing concepts in the CDB 150. For example, for an input image including a portion showing a German Shepherd dog, in which the portion matches an existing concept of “dog” stored in the CDB 150, the reduced representation may include signatures representing other characteristics of the dog such as “long black nose,” “brown eyes,” and “wolf-like body.”

A concept generator (CG) 140 is configured to create concepts based on the reduced representations generated by the RRG 110. To this end, the CG 140 may be configured to match signatures of the reduced representation to signatures of MMCEs in a world database accessible over one or more data sources (such as servers and databases accessible over the Internet, not shown) via the network interface 160. The MMCEs stored in the data sources may be tagged (i.e., such that their content is known), or untagged.

Each created concept includes a collection of signatures such as the signatures of a portion of the reduced representation that was matched to one or more MMCEs and the signatures (or portions thereof) of the one or more matching MMCEs for that portion of the reduced representation.

Each concept further includes metadata. To this end, in an embodiment, a metadata analyzer (MA) 170 is configured to determine the metadata to be included in each concept based on the reduced representation, the respective matching MMCEs, or both. The MA 170 may be configured to determine the metadata by querying one or more data sources (not shown) such as, but not limited to, databases, servers, web sources, and the like. The data sources include reference metadata of various MMCEs, and may further include signatures representing the reference metadata. In some implementations, the data sources may be, or may include, at least a portion of the world database.

The query for metadata may be performed using the collection of signatures to be included in the respective concept. The collection of signatures may be compared to signatures generated for metadata in the data sources. The metadata may include, but is not limited to, tags or other descriptive metadata, source information, hashtags, and the like. The determined metadata for each respective collection of signatures is sent to the CG 140 to be utilized to generate the concepts.

The created concepts are stored in the concept database (CDB) 150 for subsequent use, thereby enriching the CDB 150. In some implementations, the CDB 150 may include two layers of data structures (or databases): one is for the concepts, and the other is for indices of original MMCEs mapped to the concept structures in the concept structures-database. To this end, the input MMCE may be stored in the CDB 150 and matched to each stored concept.

As noted above, each concept is a collection of signatures and metadata describing the concept. The result is a compact representation of a concept that can now be easily compared against a MMCE to determine if the MMCE matches a concept structure stored, for example, in the CDB 150. As a result, the number of concept structures significantly smaller than the number of MMCEs utilized to generate the concepts. Therefore, the number of indices required in the CDB 150 is significantly smaller relative to a solution that requires indexing of raw MMCEs.

Each concept includes metadata that textually represents the content represented by the concept. Accordingly, the matching of concepts to MMCEs can be performed, for example, by providing a query to the CDB 150 (e.g., a query received via the network interface 160) for finding a match between a concept structure and a MMCE. Because the metadata of the concept includes reference metadata of matching MMCEs, the metadata provides an accurate textual representation of the content represented by the concept. For example, a concept related to a cat may be represented by metadata including the term “manx cat” (a particular breed of cat) when the collection of signatures of the concept includes signatures representing MMCEs showing visual depictions of manx cats at different angles, with different colors, and the like.

For example, if one billion (10̂9) MMCEs need to be checked for a match against another one billon MMCEs, typically the result is that no less than 10̂9×10̂9=10̂18 matches have to take place, a daunting undertaking. The concept database enhancer 100 would typically have around 10 million concept structures or less, and therefore at most only 2×10̂6×10̂9=2×10̂15 comparisons need to take place, a mere 0.2% of the number of matches that have had to be made by other solutions. The number of generated indices is at most 2×10̂5. As the number of concept structures grows significantly slower than the number of MMCEs, the advantages of the concept database enhancer 100 would be apparent to one with ordinary skill in the art.

In an embodiment, the concept database enhancer 100 is implemented via one or more processing circuitries, each coupled to a memory (not shown in FIG. 1). The concept database enhancer 100 may further include an array of at least partially statistically independent computational cores configured as described in more detail herein below.

The processing circuitry may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry may be realized as an array of at least partially statistically independent computational cores. The properties of each computational core are set independently of those of each other core, as described further herein above.

The memory may be volatile (e.g., RAM, etc.), non-volatile (e.g., ROM, flash memory, etc.), or a combination thereof. The memory may be configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry, cause the processing circuitry to perform the various processes described herein. Specifically, the instructions, when executed, configure the processing circuitry to perform concept database enrichment as described herein.

It should be understood that the embodiments described herein are not limited to the specific architecture illustrated in FIG. 1, and that other architectures may be equally used without departing from the scope of the disclosed embodiments. In particular, the concept database enhancer 100 may be communicatively connected to a separate signature generator system configured to generate signatures as described herein instead of including the signature generator 120 without departing from the scope of the disclosed embodiments.

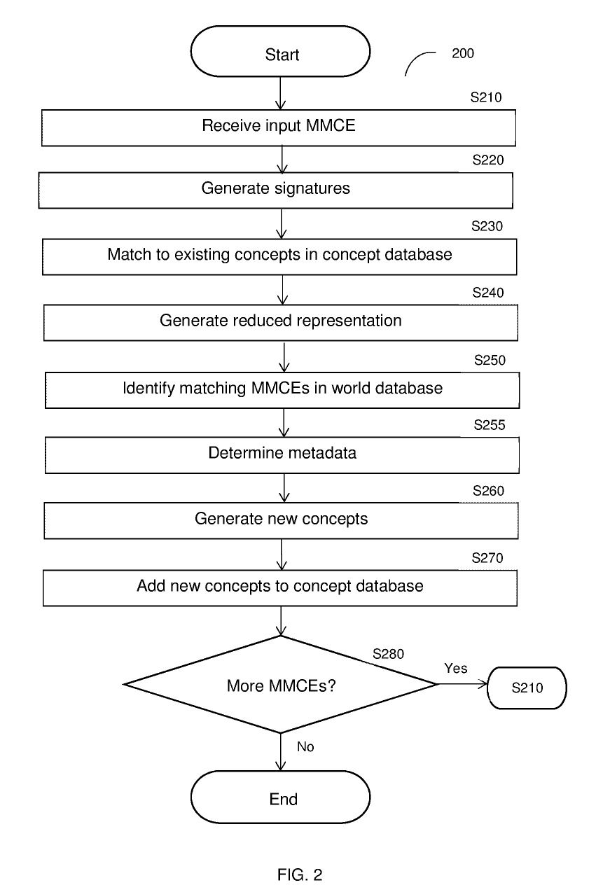

FIG. 2 depicts an example flowchart 200 illustrating a method for enriching a concept database according to an embodiment. In an embodiment, the method is performed by the concept database enhancer 130.

At S210, an input multimedia content element is received or retrieved. The input multimedia content element may be received from, e.g., a user device, or an indicator of the input multimedia content element may be utilized to retrieve the input multimedia content element. The indicator may be, e.g., a pointer to a location in storage.

At S220, one or more signatures are generated for the image. In some embodiments, the signatures may be generated by a signature generator system as described herein. It should be noted that, at least in some embodiments, other types of signatures may be utilized.

In an embodiment, S220 includes generating the signatures via a plurality of at least partially statistically independent computational cores, where the properties of each core are set independently of the properties of the other cores. In another embodiment, S220 includes sending the multimedia content element to a signature generator system, and receiving the signatures from the signature generator system. The signature generator system includes a plurality of at least statistically independent computational cores as described further herein.

At S230, based on the generated signatures, the input MMCE is matched to existing concepts in a concept database (e.g., the CDB 150, FIG. 1). In an embodiment, S230 includes matching the generated signatures to signatures representing or included in the existing concepts and determining, based on the matching, each portion of the input MMCE that matches an existing concept. The portions matching the existing concepts may be, for example, portions of the input MMCE represented by portions of the generated signatures that match one of the existing concepts. The matching may be based on, for example, a predetermined threshold.

In an optional embodiment, S230 may include performing a cleaning process to remove signatures representing portions of the MMCE that are determined to match existing concepts. This cleaning process allows for reducing utilization of computing resources related to performing the signature comparisons by excluding portions of the signatures that have already been determined to match existing concepts from subsequent matching. The cleaning process may be performed, for example, recursively as matches are determined. Thus, the cleaning process may be performed in real-time in order to reduce computing resource utilization during the matching.

At S240, a reduced representation of the input MMCE is generated based on the matching. The reduced representation represents portions of the input MMCE excluding portions that match existing concepts. The reduced representation may include signatures representing the portions of the input MMCE that do not match existing concepts such that the reduced representation represents the “new” portions of the input MMCE with respect to the concept database.

At S250, matching MMCEs available in a world database are identified. The world database may include one or more data sources available, for example, over the Internet. The matching MMCEs are MMCEs matching portions of the reduced representation. To this end, S250 may include comparing signatures or portions thereof of the reduced representation to signatures of the MMCEs in the data sources. The matching MMCEs may include MMCEs matching at least a portion of the reduced representation above a predetermined threshold.

At S255, metadata is determined for each portion of the reduced representation for which one or more matching MMCEs was determined. In an embodiment, S255 includes querying one or more data sources using a collection of signatures for each portion of the reduced representation. The collection of signatures for each portion includes a signature that is the respective portion of the reduced representation and signatures of the matching MMCEs for the portion.

At S260, based on the reduced representation and the matching MMCEs, one or more new concepts are generated. Each new concept includes a respective collection of signatures. Each new concept further includes the respective determined metadata.

At S270, the generated concepts are added to the concept database, thereby enriching the concept database. In an embodiment, S270 may further include storing the matching MMCEs mapped to each concept.

At S280, it is checked if more MMCEs are available for enriching and, if so, execution continues with S210. Additional MMCEs may be processed, for example, until each MMCE of a set of new MMCEs is processed and utilized to enrich the concept database.

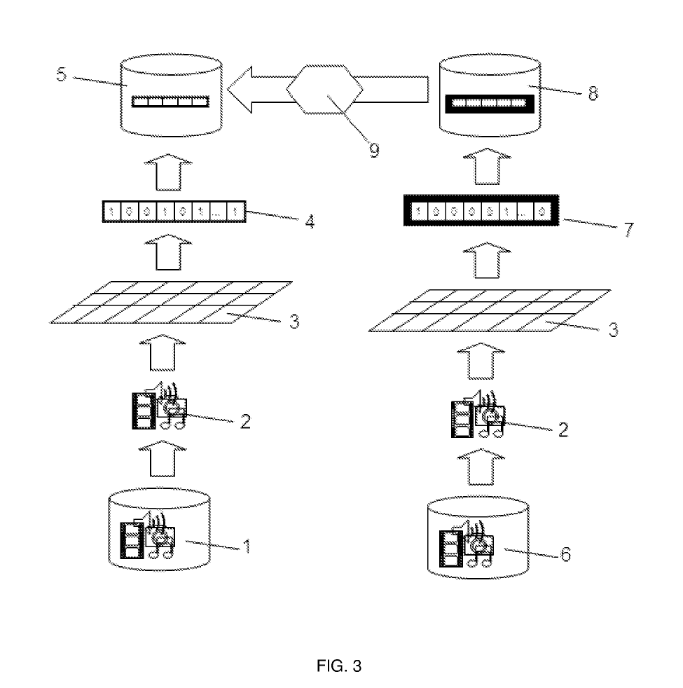

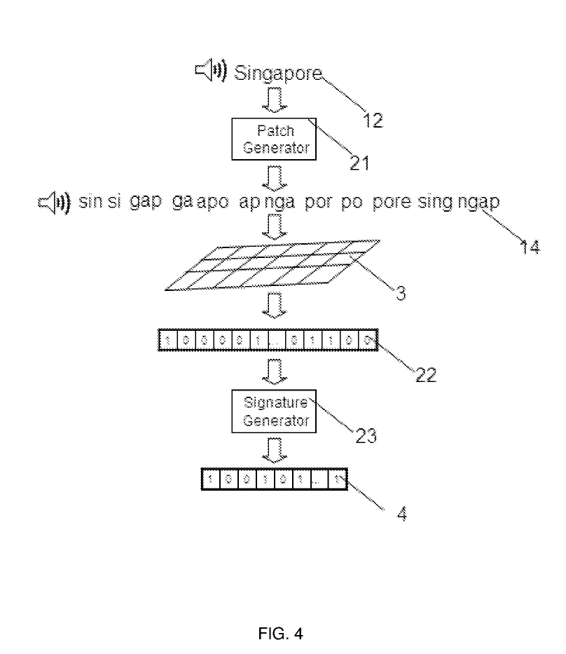

FIGS. 3 and 4 illustrate the generation of signatures for the multimedia content elements by the signature generator 120 according to an embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the server 130 is configured with a plurality of computational cores to perform matching between signatures.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≤i≤L) may consist of a single leaky integrate-to-threshold unit (LTU) node or more nodes. The node nᵢ equations are:

$${V}_{i} = {\sum }_{j}^{ } {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Th_{X} are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{I}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above, the contents of which are hereby incorporated by reference.

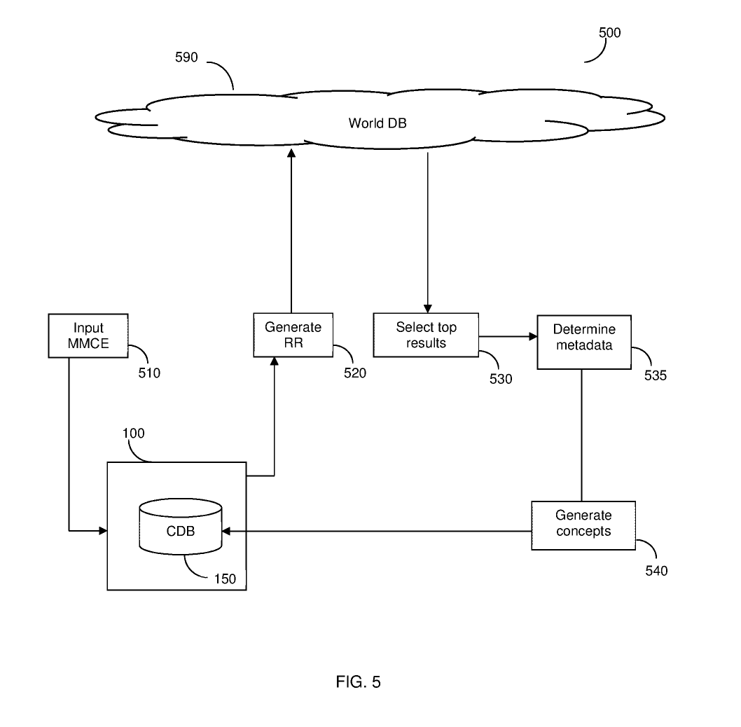

FIG. 5 is a flow diagram 500 illustrating an example enrichment of the CDB 150. An input MMCE 510 is received by the concept database enhancer 100 including the CDB 150. Signatures are generated to the input MMCE 510 and matched to signatures of concepts stored in the CDB 150. Based on the matching, the concept database enhancer 100 outputs a reduced representation 520 of the input MMCE 510. The reduced representation 520 is utilized to query the world database 590, which returns results including matching MMCEs. The top results 530 are selected. Based on the top results 530, metadata 535 is determined and utilized to generate one or more new concepts 540. The new concepts 540 are stored in the CDB 150.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for enriching a concept database, comprising:
determining, based on signatures of a first multimedia content element (MMCE) and signatures of a plurality of existing concepts in the concept database, at least one first concept, wherein each first concept is one of the plurality of existing concepts matching a portion of the first MMCE;
generating a reduced representation of the first MMCE, wherein the generation of the reduced representation includes removing the at least one portion of the first MMCE matching the determined at least one first concept;
comparing the reduced representation to signatures representing a plurality of second MMCEs to determine a plurality of matching second MMCEs for each portion of the reduced representation;
determining, based on the reduced representation and the signatures of the plurality of matching second MMCEs, metadata for each portion of the reduced representation;
generating a second concept for each portion of the reduced representation, wherein each second concept includes a collection of signatures and the determined metadata for the respective portion; and
adding the generated at least one second concept to the concept database.

2. The method of claim 1, wherein determining the at least one first concept further comprises:
performing a cleaning process, wherein the cleaning process includes removing at least one signature of the first MMCE, wherein each removed signature matches signatures of one of the at least one first concept above a predetermined threshold.

3. The method of claim 2, wherein the cleaning process is performed recursively when each first concept is determined.

4. The method of claim 1, wherein determining the metadata for each portion of the reduced representation further comprises:
querying at least one data source using the collection of signatures for the portion, wherein the determined metadata includes metadata associated with at least one search result.

5. The method of claim 1, wherein each MMCE is at least one of: an image, a graphic, a video stream, a video clip, a video frame, a photograph, and an image of signals.

6. The method of claim 5, wherein the image of signals is an image of any of: medical signals, geophysical signals, subsonic signals, supersonic signals, electromagnetic signals, and infrared signals.

7. The method of claim 1, wherein each concept is a collection of signatures and metadata representing the concept.

8. The method of claim 1, wherein each signature is generated by a signature generator system, wherein the signature generator system includes a plurality of at least statistically independent computational cores, wherein the properties of each core are set independently of the properties of each other core.

9. The method of claim 8, wherein generating the at least one signature further comprises:
sending the image to the signature generator system; and
receiving, from the signature generator system, the at least one signature.

10. A non-transitory computer readable medium having stored thereon instructions for causing a processing circuitry to execute a process for enriching a concept database, the process comprising:
determining, based on signatures of a first multimedia content element (MMCE) and signatures of a plurality of existing concepts in the concept database, at least one first concept, wherein each first concept is one of the plurality of existing concepts matching a portion of the first MMCE;
generating a reduced representation of the first MMCE, wherein the generation of the reduced representation includes removing the at least one portion of the first MMCE matching the determined at least one first concept;
comparing the reduced representation to signatures representing a plurality of second MMCEs to determine a plurality of matching second MMCEs for each portion of the reduced representation;
determining, based on the reduced representation and the signatures of the plurality of matching second MMCEs, metadata for each portion of the reduced representation;
generating a second concept for each portion of the reduced representation, wherein each second concept includes a collection of signatures and the determined metadata for the respective portion; and
adding the generated at least one second concept to the concept database.

11. A system for enriching a concept database, comprising:
a processing circuitry; and
a memory connected to the processing circuitry, the memory containing instructions that, when executed by the processing circuitry, configure the system to:
determine, based on signatures of a first multimedia content element (MMCE) and signatures of a plurality of existing concepts in the concept database, at least one first concept, wherein each first concept is one of the plurality of existing concepts matching a portion of the first MMCE;
generate a reduced representation of the first MMCE, wherein the generation of the reduced representation includes removing the at least one portion of the first MMCE matching the determined at least one first concept;
compare the reduced representation to signatures representing a plurality of second MMCEs to determine a plurality of matching second MMCEs for each portion of the reduced representation;
determine, based on the reduced representation and the signatures of the plurality of matching second MMCEs, metadata for each portion of the reduced representation;
generate a second concept for each portion of the reduced representation, wherein each second concept includes a collection of signatures and the determined metadata for the respective portion; and
add the generated at least one second concept to the concept database.

12. The system of claim 11, wherein the system is further configured to:
perform a cleaning process, wherein the cleaning process includes removing at least one signature of the first MMCE, wherein each removed signature matches signatures of one of the at least one first concept above a predetermined threshold.

13. The system of claim 12, wherein the cleaning process is performed recursively when each first concept is determined.

14. The system of claim 11, wherein the system is further configured to:
query at least one data source using the collection of signatures for each portion of the reduced representation, wherein the determined metadata includes metadata associated with at least one search result.

15. The system of claim 11, wherein each MMCE is at least one of: an image, a graphic, a video stream, a video clip, a video frame, a photograph, and an image of signals.

16. The system of claim 15, wherein the image of signals is an image of any of: medical signals, geophysical signals, subsonic signals, supersonic signals, electromagnetic signals, and infrared signals.

17. The system of claim 11, wherein each concept is a collection of signatures and metadata representing the concept.

18. The system of claim 11, wherein each signature is generated by a signature generator system, wherein the signature generator system includes a plurality of at least statistically independent computational cores, wherein the properties of each core are set independently of the properties of each other core.

19. The system of claim 18, wherein the system is further configured to:
send the image to the signature generator system; and
receive, from the signature generator system, the at least one signature.

20. The system of claim 11, wherein the system further comprises the concept database.
